(19) United States
(12) Patent Application Publication
(10) Pub. No.: US 2004/0075300 A1
(43) Pub. Date: Apr. 22, 2004

(54) Flat element and method for producing a flat element

(76) Inventors: Hartmut Carstensen, Berlin (DE); Peter Buchwald, Bergfelde (DE); Fna Meyer, Schildow (DE)

Correspondence Address: HOWREY SIMON ARNOLD & WHITE, CITYPOINT, ONE ROPEMAKER STREET, LONDON, EC2Y 9HS, GB

(21) Appl. No.: 10/204,485

(22) PCT Filed: Feb. 17, 2001
(86) PCT No.: PCT/EP01/01780

(30) Foreign Application Priority Data
Feb. 21, 2000 (DE) 100 09 105.9

(51) Int. Cl. B61D 17/00; B61D 17/08; B61D 25/00; F16B 5/04; F16B 5/06; F16B 11/00; B32B 7/08; B32B 3/12; B32B 31/04

(52) U.S. Cl. 296/191; 29/897.2; 29/524; 29/524.1; 29/522.1; 105/401; 428/594; 156/92; 156/91; 156/285; 156/292

(57) ABSTRACT

In the present method for producing a planar element (2) for car bodies in sandwich construction, which includes an external skin (4) and a hump plate (6) having edge profiles (8, 10) arranged between them, in a first step the edge profiles (8, 10) are joined to the hump plate (6), at least partially using a mechanical joining method, in a second step the hump plate (6) is glued to the external skin (4), and in a third step the edge profiles (8, 10) are joined to the external skin (4), at least partially using a mechanical joining method. Through these measures, high shear and buckling resistance of the planar element is achieved.

The present invention relates to a method for producing a planar element for car bodies in sandwich construction on a planar element.

Car bodies, for example for passenger traffic, are constructed from various components. These components include, among other things, planar elements. The planar elements are in turn assembled from multiple plates and semifinished products, which are joined to one another. Various welding techniques, such as spot welding and conventional electrical arc welding, are used as joining techniques in this case.

In railway vehicle construction it has been typical and very generally known until now to implement components for car bodies of railway vehicles in differential construction, a framework or latticework joined out of profiles being provided with external skin, which is connected to the framework in such a way that planar elements which are resistant to tension and pressure result. In the areas lying between the lattice rods, the skin is additionally reinforced on the inside by linear, frequently Z-shaped profiles as buckling stiffeners.

For example, a planar element and a method for its production is known from German Patent 195 21 892 C1. The planar element includes two cover plates and multiple ribs, which stiffen the cover plates and connect them to one another via rigid connections. The ribs are arranged in a lattice shape to form cells. Rigid connections are produced in this case by thermally penetrating joining using laser welding, the rigid connections being implemented as weld seams which extend over almost the entire length of the components to be joined.

Implementing a latticework for large car bodies from cap-shaped profiles, which are overlapped at their crossing points by profile nodes, also implemented as cap-shaped, and are joined to them by form fitting and material bonding, is known from Great Britain Patent 885,279.

In the cases described above, thermal joining methods are used completely or at least in some sections for the production of the framework or latticework, for the joining to the external skin, and for the subsequent application of the linear buckling stiffeners. It is disadvantageous for all of these joining methods that high precision must be ensured and therefore corresponding expense must be made during the forming of the framework or latticework, and the heat introduced leads to undesired tensions and distortion in all components, which requires time-consuming and costly reworking in order to produce the desired shape and surface evenness of the planar element and remain within the required tolerances.

In addition, a significant thermal distortion arises, which becomes noticeable in the occurrence of buckling and negatively influences the surface quality. To compensate the distortion, extensive alignment and clamping work as well as reworking through renewed grinding are necessary. The dimensional tolerances arising lead to elevated adjustment expense in the final assembly. The known joining methods require extensive subsequent corrosion protection or the use of costly stainless steels. To produce a suitable planar buckling resistance, it is necessary to thermally tension the planar elements in a subsequent treatment or provide them with profile buckling stiffeners.

In addition, these joining methods restrict or prevent the use of materials which already contain inorganic or organic corrosion protection films, the production of largely premanufactured components, which, for example, already have a thermal insulation or a final coloration, and the production of hybrid components joined from different materials (including fiber composite materials).

Therefore, replacing thermal joining methods by cold joining methods is increasingly being attempted in the manufacture of railway vehicles.

Joining a latticework and linear buckling stiffeners to an external skin using a gluing method is described in German Patent Application 195 01 805 A1. This technology is not usable and cost effective for all applications.

Planar element modules which are at least partially producible and joinable to one another using cold joining (e.g. punch rivets) in differential construction are known from European Patent Application 0 855 978 A1. This technology sometimes requires high outlay for devices and tools, and its construction is relatively restricted and complicated.

These previously known methods of joining for the production of car bodies have various disadvantages. Hollow chamber profiles are costly to design and produce, with extensive and inflexible cast nodes arising and no tolerance compensation being provided. The edge designs of the planar elements in the region profile/plate have also been shown to be very complicated.

The production of a frame, constructed of ribs, for example, is also complicated and costly. The use of structure-supporting foam cores is typical, which in turn requires the use of expensive foams, which are exclusively glued. Mechanical tension peaks in the edge regions are unavoidable.

The use of a hump plate is described, among other things, in P. Cordes, V. Hüller: Moderne Stahl-Leichtbaustrukturen für den Schienenfahrzeugbau; Blech Rohre Profile [Modem Steel Lightweight Structures for Railway Vehicle Construction; Plate Tube Profile] 42 (1995) 12 pp. 773-777. In this hump plate, a smooth plate is connected to a second plate, into which a defined raster of truncated cones or pyramids was shaped. The smooth plate and the hump plate are connected to one another via a spot weld in each of the hump bottoms.

German Patent application DE-AS 1 133 640 describes a wall component for car bodies of motor vehicles. The wall component consists of shells connected to one another in pairs, one of which is provided with cup-like depressions and the other of which has an essentially uniform continuous surface, the shells being connected to one another at the depressions. If plastic shells are used, the bottoms of the depressions of one shell are joined by an adhesive bond to the other shell. If they are arranged offset, the joined surfaces are in total approximately equal to the areas remaining free between the depressions.

German Patent Application 197 42 772 A1 includes an intermediate floor for a two-story railway car to separate the upper story from the lower. The intermediate floor extends from one lengthwise side of the car to the other and over a section of the length of the car. It consists of multiple flat, rectangular sandwich elements lying next to one another, whose narrow faces extend from one lengthwise side of the car to the other and there lie on a girder running in the lengthwise direction of the car, while their wide lengthwise sides are each connected to a hollow and pliable bar, which extends transversely over at least a section of the inner breadth of the car. In one embodiment, the sandwich elements consist of two plates which have a cell structure, in that depressions are shaped into each of the plates by deep drawing. The tips of the depressions are in contact and are welded to one another.

The present invention has the object of indicating a method for producing a planar element for car bodies in sandwich construction, planar elements being manufactured with lower tolerance margin and high surface quality. In addition, a planar element produced according to the method according to the present invention is to be indicated.

This object is achieved by a method for producing a planar element for car bodies in sandwich construction having the features of claim 1.

This object is also achieved by a planar element produced in this way.

A high shear and buckling resistance of the planar element is achieved using the method for producing a planar element. Only low tolerance margins arise, the leveling of the plate occurring automatically. Through application of the method, multifaceted functional integration is achieved, corrosion protection and sound insulation being emphasized. Very low component tolerances are achieved through the use of cold joining methods. In addition, significant financial savings are achieved by dispensing with wage-intensive processes, such as aligning, sandblasting, clamping, grinding, and filling. Furthermore, material costs are saved. Base coats may be dispensed with, only undercoats, covering varnish, or foil being necessary. In addition, both hybrid construction and modular construction are made possible using the present method. Planar elements having various profiles may be produced, for example flat or curved side walls. The production of a complicated separate frame is avoided and the use of structure-supporting foam cores is dispensed with.

Preferably, mechanical joining is used exclusively in the first and third steps. By dispensing with the use of welding methods, the advantages already indicated are further optimized. Peeling forces in the adhesive are avoided through the mechanical joining.

The cold joining may particularly be performed using punch rivets or clinching. A combination of both methods is also conceivable. These joining techniques ensure joins having low tolerances, since a shrinking process, which is difficult to calculate and is unavoidable with welding, is avoidable with cold joining.

In a further embodiment of the present invention, uprights are arranged and attached for stabilization on the side of the hump plate facing away from the external skin in the first step. The assembly even in this early phase of the method simplifies the overall production process for planar elements.

The hump plate is preferably glued to the external skin in a vacuum bag method. For example, the plates to be glued are introduced into an airtight package, for example into a film, in which a partial vacuum is subsequently generated. Using a vacuum bag method, flat surfaces may be produced with the highest precision in a cost-effective way. The method has been shown to be independent of the size of the planar element. Costly individual devices for producing flat planar elements which are dependent on the size of the planar elements are no longer necessary.

Advantageous refinements result from the sub-claims.

The present invention will be described in more detail on the basis of an exemplary embodiment in connection with the attached drawing.

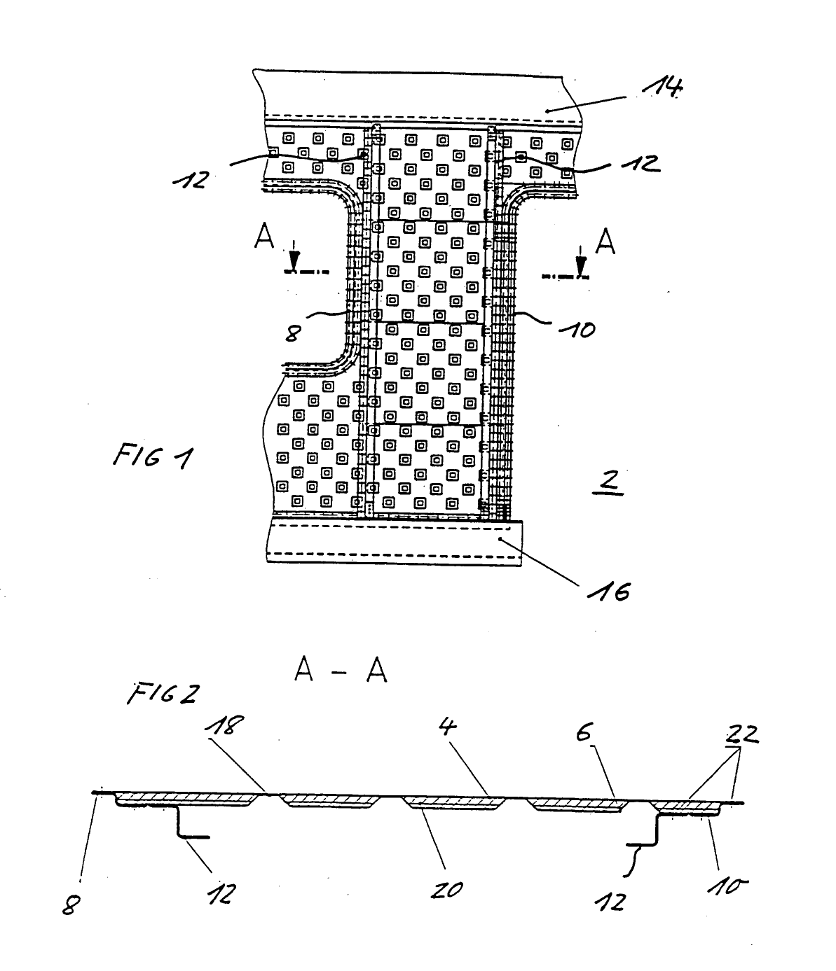

FIG. 1 shows a detail of a planar element for car bodies in sandwich construction in a top view in a schematic illustration;

FIG. 2 shows a section from FIG. 1 along line A-A.

FIG. 1 shows a detail of a planar element 2 for car bodies in sandwich construction in a top view in schematic illustration. Planar element 2 includes external skin 4 and a hump plate 6, external skin 4 only being illustrated in FIG. 2.

The humps of hump plate 6 may be implemented in a flat, regular arrangement in intersecting horizontal and vertical rows or in intersecting diagonal rows.

Edge profiles 8, 10, which are implemented in this exemplary embodiment as window and/or door frames, are provided for the mechanical attachment of external skin 4 to hump plate 6.

In addition, vertical uprights 12 are arranged for stabilization on the side of hump plate 6 facing away from external skin 4. Planar element 2 is clamped between a roof longitudinal member 14 and an undercarriage longitudinal member 16, so that the vertical uprights run perpendicular to roof longitudinal member 14 and undercarriage longitudinal member 16.

A section of planar element 2 from FIG. 1 along line A-A is illustrated in FIG. 2. In the present method for producing planar element 2 for car bodies in sandwich construction, in a first step, a first section of edge profiles 8, 10 is joined to hump plate 6, at least partially using a mechanical joining method. Together with the uprights 12 arranged on hump plate 6, a reinforced sandwich inner shell has already been manufactured.

In a second step, hump plate 6 is glued to external skin 4 with the aid of an adhesive 18. The gluing is preferably performed in a vacuum bag method. The gluing may, however, also be performed in another way. In addition, an insulating material 20 is located in the spaces implemented between external skin 4 and hump plate 6. In this exemplary embodiment, the arrangement to be glued is introduced into an airtight package, for example into a film, in which a partial vacuum is subsequently generated. The hump plate may, however, be pressed onto the external skin in another way.

In a third step, a second section of edge profiles 8, 10 is joined to external skin 4, at least partially using a mechanical joining method. The joining in the first and third sections may also be completely mechanical.

The cold joining in the first and third step is performed in this example using punch rivets 22. In a further exemplary embodiment (not shown) the cold joining is performed using clinching. However, other cold joining techniques, for example blind rivets, may also be used. The edge profiles at least partially have a Z-profile.

Using the present method for producing a planar element 2 for car bodies in sandwich construction, high shear and buckling resistance of entire planar element 2 is achieved. Only slight tolerance margins arise, the leveling of the external plate occurring automatically through the gluing process.

1. A method for producing a planar element (2) for car bodies in sandwich construction,
characterized in that
in a first step, a first section of the edge profiles (8, 10) is joined with a hump plate (6), at least partially using a mechanical joining method,
in a second step, the hump plate (6) is glued to an external skin (4), and
in a third step, a second section of the edge profiles (8, 10) is joined to the external skin (4), at least partially using a mechanical joining method, to connect the external skin (4) to the hump plate (6).

2. The method according to claim 1,
characterized in that the first and third steps are entirely performed using cold joining.

3. The method according to one of claims 1 or 2,
characterized by cold joining using punch rivets (22).

4. The method according to one of claim 1 or 2,
characterized by cold joining using clinching.

5. The method according to one of claims 1 to 4,
characterized in that, in the first step, uprights (12) are arranged for stabilization on the side of the hump plate (6) facing away from the external skin (4).

6. The method according to one of claims 1 to 5,
characterized in that the hump plate (6) is glued to the external skin (4) in a vacuum bag method.

7. The method according to one of claims 1 to 6,
characterized in that the edge profiles (8, 10) are at least partially implemented as Z-profiles.

8. A planar element (2), which is produced according to a method of claims 1 to 7.

9. The planar element according to claim 8,
characterized in that the hump plate (6) is connected to the external skin (4) so it is shear-resistant.

10. The planar element (2) according to claim 9,
characterized in that the humps of the hump plate (6) are implemented in a plane, regular arrangement in intersecting rows running horizontally and vertically.

11. The planar element (2) according to claim 9,
characterized in that the humps of the hump plate (6) are implemented in a plane, regular arrangement in intersecting rows running diagonally.
